(19) United States
(12) Patent Application Publication
(10) Pub. No.: US 2026/0087939 A1
(43) Pub. Date: Mar. 26, 2026

(54) GUITAR PLAYING SYSTEM AND METHODS OF OPERATING THE SAME

(71) Applicant: John W Forsythe, Blooming Glen, PA (US)

(72) Inventor: John W Forsythe, Blooming Glen, PA (US)

(21) Appl. No.: 19/327,294

(22) Filed: Sep. 12, 2025

Related U.S. Application Data
(60) Provisional application No. 63/697,088, filed on Sep. 20, 2024.

(51) Int. Cl. G09B 15/00; G10D 3/08; G10G 1/02

(52) U.S. Cl. CPC G09B 15/003; G10D 3/08; G10G 1/02

(57) ABSTRACT

A guitar playing unit includes a touch panel with a plurality of touch sensitive regions electronically connected to a microcontroller; a solenoid board supporting a plurality of solenoids, each touch sensitive region of the plurality of touch sensitive regions is associated with and electronically connected to at least one solenoid of the plurality of solenoids, each solenoid being in fluid communication with an air source; a manifold unit including a plurality of air holes, wherein each air hole of the plurality of air holes is in fluid communication with at least one solenoid of the plurality of solenoids; a plurality of pistons in fluid communication with the plurality of air holes, each piston of the plurality of pistons includes a piston head configured to engage a string of a guitar at a fret location; and a neck clamping unit configured to secure the guitar playing unit to a neck of the guitar.

### STATEMENT OF RELATED APPLICATION(S)

This application claims the benefit of U.S. Provisional Ser. No. 63/697,088 filed on Sep. 20, 2024, the disclosure of which is hereby incorporated by reference herein in its entirety.

### TECHNICAL FIELD

This invention relates to the field of guitars and devices to assist players in learning and playing guitars.

### BACKGROUND

Playing the guitar can be difficult for many individuals. Instructors, video tutorials, and software are used to teach people how to play the guitar on virtual versions of a guitar. When a user leaves a training session or moves to playing a physical guitar, the lessons learned previously must be replayed from memory, making mastering the playing of a guitar an arduous process. Moreover, the physical demands of playing a guitar make it challenging, difficult, or nearly impossible for some due to physical limitations or conditions such as arthritis, carpal tunnel syndrome, or other motion inhibiting conditions. If the strings are not pressed down sufficiently, the sound of the chord does not ring, and many chords require all 6 strings to be pressed down in the same fret (known as “bar chords”), which requires a great deal of strength in the hands and fingers. Many beginning guitar players are discouraged by their inability to play such chords.

Therefore, a need exists for a system that fits onto a guitar to train individuals to play the guitar.

### SUMMARY

In a first aspect of the claimed invention, a guitar playing unit includes a touch panel including a plurality of touch sensitive regions electronically connected to a microcontroller; a solenoid board supporting a plurality of solenoids, each touch sensitive region of the plurality of touch sensitive regions is associated with and electronically connected to at least one solenoid of the plurality of solenoids, each solenoid being in fluid communication with an air source; a manifold unit including a plurality of air holes, each air hole of the plurality of air holes is in fluid communication with at least one solenoid of the plurality of solenoids; a plurality of pistons in fluid communication with the plurality of air holes, each piston of the plurality of pistons including a piston head configured to engage a string of a guitar at a fret location; and a neck clamping unit configured to secure the guitar playing unit to a neck of the guitar.

In another aspect, the microcontroller is configured to detect if a user has touched one or more of the plurality of touch sensitive regions.

In another aspect, when one touch sensitive region of the plurality of touch sensitive regions is touched, the microcontroller sends an actuation signal to the corresponding at least one solenoid to open.

In another aspect, when the at least one solenoid is open, air flows from the air supply to the corresponding piston of the plurality of pistons, thereby causing the piston to extend and contact the guitar string.

In another aspect, the plurality of pistons includes one or more sub-groups, each sub-group corresponding to a different fret location on the guitar

In another aspect, the manifold unit includes an upper manifold plate, a manifold gasket, and a lower manifold plate.

In another aspect, the upper manifold plate includes a plurality of air passages in fluid communication with the plurality of air holes.

In another aspect, each air passage of the plurality of air passages is located within a same plane, each air hole of the plurality of air holes is substantially parallel, and the plurality of air passages is substantially orthogonal to the plurality of air holes.

In another aspect, a proximal end of each piston of the plurality of pistons is positioned adjacent one end of each air passage and in fluid communication therewith.

In another aspect, the manifold gasket includes a plurality of gasket piston openings, and the lower manifold plate includes a plurality of lower piston openings, each gasket piston opening aligned with and concentric with a corresponding one lower piston opening.

In another aspect, each gasket piston opening and corresponding lower piston opening is configured to receive a piston body of a corresponding piston of the plurality of pistons.

In another aspect, the neck clamping unit includes an upper clamp portion pivotably connected to a lower clamp portion.

In another aspect, the lower clamp portion is sized and shaped to receive at least a portion of the neck of the guitar.

In another aspect, the upper clamp portion further comprises an extension arm with a locking tab, the lower clamp portion further comprises a locking opening, and when the upper clamp portion is pivoted towards the lower clamp portion, the locking tab is configured to be inserted into the locking opening.

In another aspect, any one or more aspects or features described herein may be combined with any one or more other aspects or features for additional advantage.

Other aspects and embodiments will be apparent from the detailed description and accompanying drawings.

Those skilled in the art will appreciate the scope of the present disclosure and realize additional aspects thereof after reading the following detailed description of the preferred embodiments in association with the accompanying drawing figures.

### BRIEF DESCRIPTION OF THE DRAWINGS

FIG. 1 is a perspective view of the guitar playing system according to a first embodiment of the present invention.

FIG. 2 is a bottom perspective view of a solenoid board of the guitar playing system of FIG. 1.

FIG. 3 is an exploded perspective view of a manifold unit of the guitar playing system of FIG. 1.

FIG. 4 is a bottom plan view of an upper manifold plate of the guitar playing system of FIG. 1.

FIG. 5 is a bottom perspective view of the manifold unit and a plurality of pistons of the guitar playing system of FIG. 1.

FIG. 6 is a perspective view of at least two clamping units of the guitar playing system of FIG. 1.

FIG. 7 is a schematic view of a microcontroller of a touch panel of the guitar playing system of FIG. 1.

FIG. 8 is a schematic diagram of a method of operating the guitar playing system of FIG. 1.

FIG. 9 is a schematic diagram of a method of operating the guitar playing system of FIG. 1.

### DETAILED DESCRIPTION

The embodiments set forth below represent the necessary information to enable those skilled in the art to practice the embodiments and illustrate the best mode of practicing the embodiments. Upon reading the following description in light of the accompanying drawing figures, those skilled in the art will understand the concepts of the disclosure and will recognize applications of these concepts not particularly addressed herein. It should be understood that these concepts and applications fall within the scope of the disclosure and the accompanying claims.

It will be understood that, although the terms first, second, etc. may be used herein to describe various elements, these elements should not be limited by these terms. These terms are only used to distinguish one element from another. For example, a first element could be termed a second element, and, similarly, a second element could be termed a first element, without departing from the scope of the present disclosure. As used herein, the term “and/or” includes any and all combinations of one or more of the associated listed items.

It will be understood that when an element such as a layer, region, or substrate is referred to as being “on” or extending “onto” another element, it can be directly on or extend directly onto the other element or intervening elements may also be present. In contrast, when an element is referred to as being “directly on” or extending “directly onto” another element, there are no intervening elements present. Likewise, it will be understood that when an element such as a layer, region, or substrate is referred to as being “over” or extending “over” another element, it can be directly over or extend directly over the other element or intervening elements may also be present. In contrast, when an element is referred to as being “directly over” or extending “directly over” another element, there are no intervening elements present. It will also be understood that when an element is referred to as being “connected” or “coupled” to another element, it can be directly connected or coupled to the other element or intervening elements may be present. In contrast, when an element is referred to as being “directly connected” or “directly coupled” to another element, there are no intervening elements present.

Relative terms such as “below” or “above” or “upper” or “lower” or “horizontal” or “vertical” may be used herein to describe a relationship of one element, layer, or region to another element, layer, or region as illustrated in the Figures. It will be understood that these terms and those discussed above are intended to encompass different orientations of the device in addition to the orientation depicted in the Figures.

The terminology used herein is for the purpose of describing particular embodiments only and is not intended to be limiting of the disclosure. As used herein, the singular forms “a,” “an,” and “the” are intended to include the plural forms as well, unless the context clearly indicates otherwise. It will be further understood that the terms “comprises,” “comprising,” “includes,” and/or “including” when used herein specify the presence of stated features, integers, steps, operations, elements, and/or components, but do not preclude the presence or addition of one or more other features, integers, steps, operations, elements, components, and/or groups thereof.

Unless otherwise defined, all terms (including technical and scientific terms) used herein have the same meaning as commonly understood by one of ordinary skill in the art to which this disclosure belongs. It will be further understood that terms used herein should be interpreted as having a meaning that is consistent with their meaning in the context of this specification and the relevant art and will not be interpreted in an idealized or overly formal sense unless expressly so defined herein.

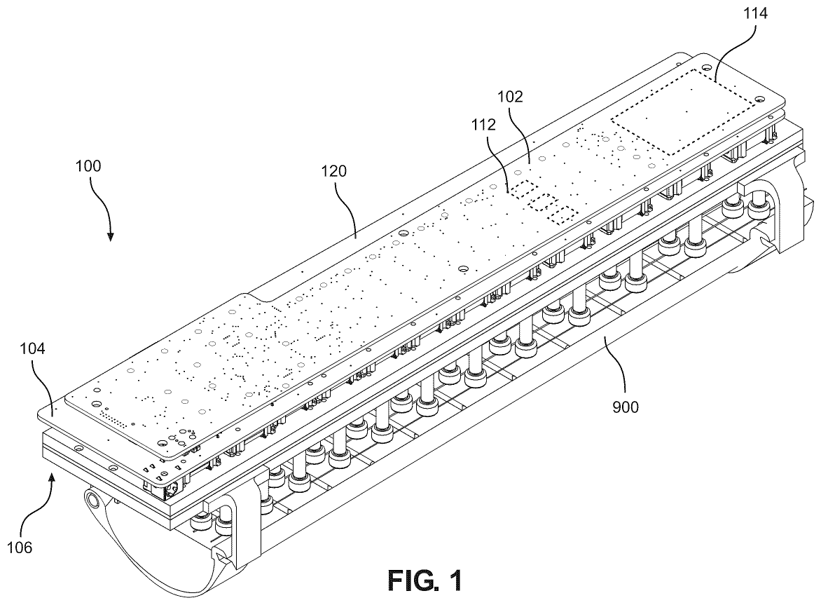

Referring to FIG. 1, a guitar playing unit 100 according to a first embodiment of the present invention is shown. The guitar playing unit 100 comprises a touch panel 102, a solenoid board 104, a manifold unit 106, a plurality of pistons 108, and at least two neck clamping units 110. Each neck clamping unit 110 of the at least two neck clamping units 110 is configured to selectively secure the guitar playing unit 100 to a neck of a guitar 900.

In an exemplary embodiment, the touch panel 102 comprises a plurality of touch sensitive regions 112 and a microcontroller 114. In an exemplary embodiment, the touch sensitive regions 112 are configured to determine if a user 910 has placed a finger on one or more touch sensitive regions 112 of the plurality of touch sensitive regions 112. In an exemplary embodiment, the one or more touch sensitive regions 112 may comprise a resistive surface, surface acoustic wave surface, a capacitive surface, a mutual capacitance surface, a self-capacitance surface, a fingerprint sensor, an infrared grid, an infrared acrylic projection surface, an optical imaging surface, a dispersive signal surface, an acoustic pulse recognition surface, and/or any other suitable touch sensitive surface. In an exemplary embodiment, the touch panel 102 may further comprise at least one LED 115 associated with each touch sensitive region 112. In an exemplary embodiment, the one or more touch sensitive regions 112 are configured to communicate with the microcontroller 114 in a wired or wireless manner. In an exemplary embodiment, the microcontroller 114 is configured to communicate with a plurality of solenoids 116 located on the solenoid board 104, as will be discussed in detail below.

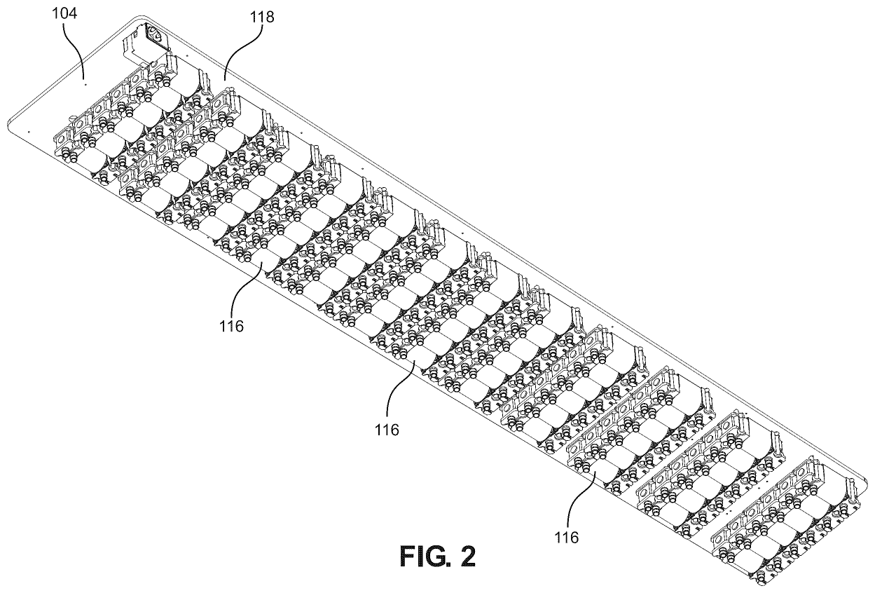

Referring now to FIG. 2, a bottom perspective view of the solenoid board 104 and the plurality of solenoids 116 is shown. The plurality of solenoids 116 being located on a first side 118 of the solenoid board 104, wherein the first side 118 faces away from the touch panel 102. The solenoid board 104 further comprises a second side 120, opposite to the first side 118, and facing toward the touch panel 102. Each solenoid 116 of the plurality of solenoid 116 is configured to receive an electrical control signal from the microcontroller 114, in order to control an open/close state of the solenoid 116. Each solenoid valve 116 is further configured to receive an air supply from an air source (not shown) through at least one air supply line and is configured to exhaust the air supply through at least one air exit line. In an exemplary embodiment, each touch sensitive region 112 of the plurality of touch sensitive regions 112 has a corresponding one solenoid 116 of the plurality of solenoids 116. In the exemplary embodiment, when the microcontroller 114 determines that the touch sensitive region 112 has been activated (i.e., by being touched by the user 910), the microcontroller 114 sends a signal to the corresponding solenoid 116 to cause the solenoid 116 to open and allow the air supply to pass therethrough. When the microcontroller 114 determines that the touch sensitive region is no longer activated (i.e., the user 910 is no longer touching the region 112), the microcontroller 114 sends a signal to the corresponding solenoid 116 to cause the solenoid 116 to close and prevent the air supply from passing therethrough. In an alternative embodiment, each touch sensitive region 112 may have more than one corresponding solenoid 116 associated therewith.

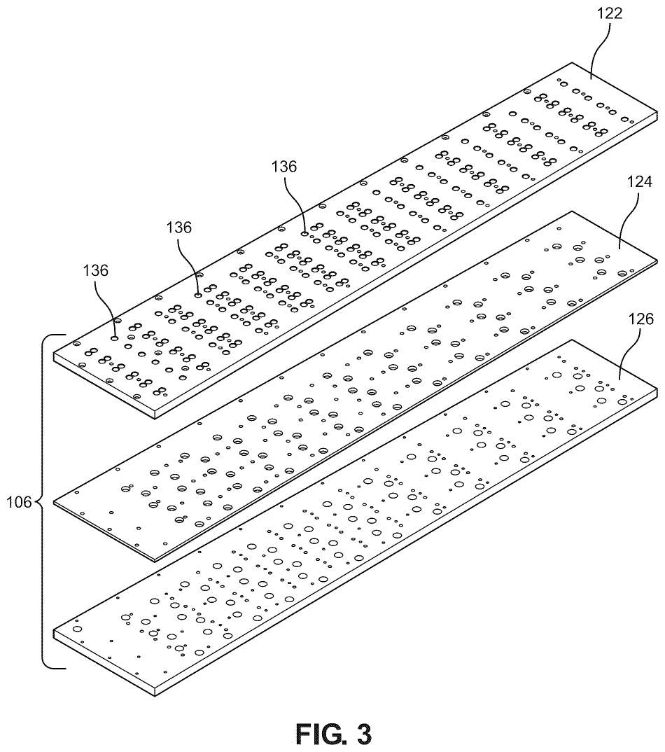

Referring now to FIG. 3, the manifold unit 106 of the guitar playing unit 100 is shown in an exploded view. The manifold unit 106 comprises an upper manifold plate 122, a manifold gasket 124, and a lower manifold plate 126. The upper manifold plate 122 and the lower manifold plate 126 are preferably formed of a rigid material. In an exemplary embodiment, the upper manifold plate 122 and the lower manifold plate 126 are formed of aluminum, steel, iron, metal, and/or any suitable rigid material. In an exemplary embodiment, the manifold gasket 124 is formed as a natural rubber, a synthetic rubber, neoprene, silicone rubber, polyurethane, an elastomeric material, a polymeric material, and/or any other suitable elastic material. In use, the manifold gasket 124 is sandwiched between the upper manifold plate 122 and the lower manifold plate 126 in order to form an airtight seal about a perimeter of the upper and lower manifold plates 122, 126.

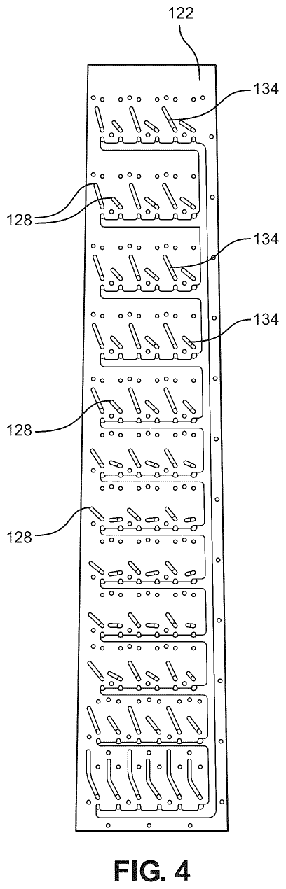

In an exemplary embodiment, the upper manifold plate 122 comprises a plurality of upper piston positions 128 (FIG. 4); the manifold gasket 124 comprises a plurality of gasket piston openings 130; and the lower manifold plate 126 comprises a plurality of lower piston openings 132. In a preferred embodiment, the number of upper piston positions 128, gasket piston openings 130, and lower piston openings 132 is equal. In a preferred embodiment, each upper piston position 128 is aligned with and concentric with a corresponding one gasket piston opening 130 and a corresponding one lower piston opening 132. The plurality of upper piston positions 128, the plurality of gasket piston openings 130, and the plurality of lower piston openings 132 are arrayed in sub-groups. Each sub-group is configured to correspond to a single fret of the guitar 900. In an exemplary embodiment, each sub-group is arranged along a single axis (e.g., each gasket piston opening 130 in a sub-group is arranged in a line). In another exemplary embodiment, each sub-group is arranged along two axes (e.g., half of the gasket piston openings 130 in a sub-group are arranged in one line and the other half of the gasket piston openings 130 in the sub-group are arranged in another line). In this exemplary embodiment, the sub-group may alternate on which axis the sub-group is arranged. In an exemplary embodiment, the number of upper piston positions 128, gasket piston openings 130, and lower piston positions 132 in each sub-group is six in order to correspond with the number of strings in a six-string guitar 900.

Referring now to FIG. 4, a bottom plan view of the upper manifold plate 122 is shown. The upper manifold plate comprises a plurality of air passages 134 and a corresponding plurality of air holes 136 therethrough. In an exemplary embodiment, each air passage 134 of the plurality of air passages 134 is formed as a groove or channel in a surface of the upper manifold plate 122 and extends substantially parallel thereto. In an exemplary embodiment, each air passage 134 of the plurality of air passages 134 has a corresponding one air hole 136 of the plurality of air holes 136 in fluid communication therewith. In an exemplary embodiment, the plurality of hair holes 136 extends completely through a thickness of the upper manifold plate 122. In an exemplary embodiment, in use, each solenoid 116 of the plurality of solenoids 116 is in fluid communication with a corresponding one air hole 136 of the plurality of air holes 136, such that the air supply passes through the solenoid 116 and through the air hole 136.

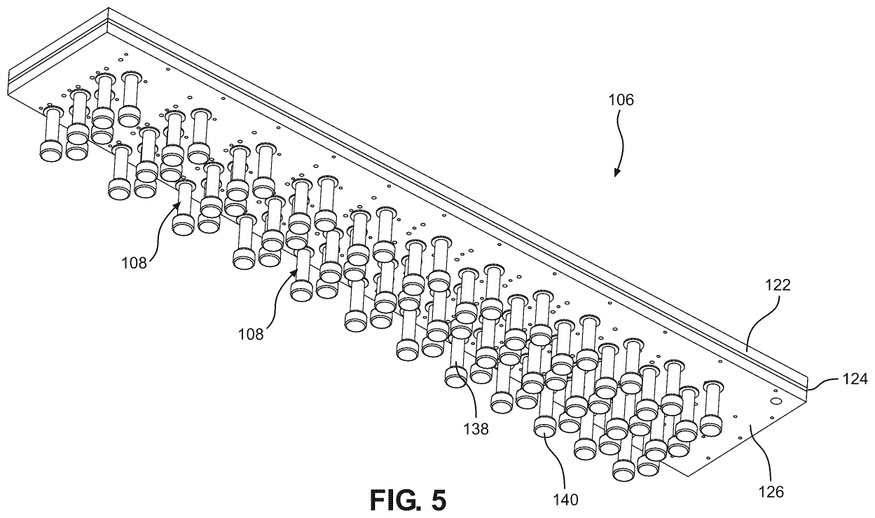

Referring also to FIG. 5, each gasket piston opening 130 and each corresponding lower piston opening 132 is configured to receive therein one piston 108 of the plurality of pistons 108. A proximal end of each piston 108 passes through the lower piston opening 132, through the gasket piston opening 130, and terminates adjacent to the upper piston position 128. Each piston 108 of the plurality of pistons 108 comprises a piston body 138, a piston shaft (not shown), a piston spring (not shown), and a piston head 140 located on a distal end of the piston shaft. The proximal end of each piston 108 is in fluid communication with the corresponding air passage 134. In an exemplary embodiment, in use, the air supply passes from the solenoid 116, through the air hole 136, and through the air passage 134 to the piston 108. The air supply causes the piston shaft to actuate to an extended position. When the air supply is stopped, the piston shaft returns to a contracted position through urging of the pistol spring. In an exemplary embodiment, the piston head 140, located on the piston shaft, is configured to engage with a corresponding guitar string when the air supply is provided and the piston shaft is in the extended position. In an exemplary embodiment, the piston head 140 may be formed as a rubber material, a polymeric material, an elastomeric material, and/or any other suitable material.

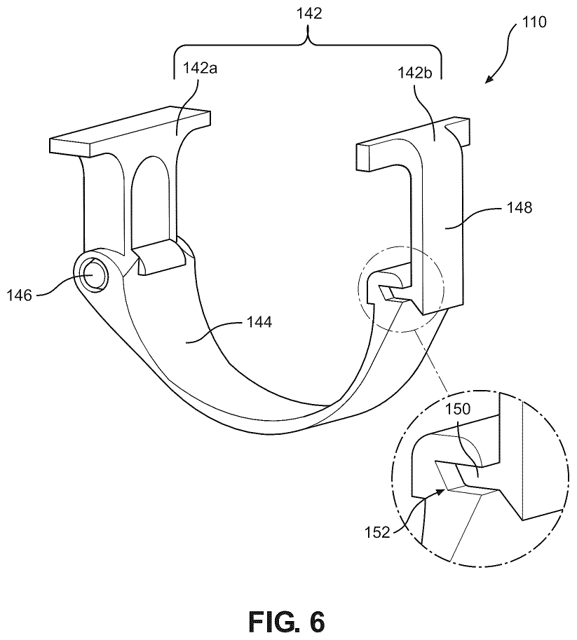

Referring now to FIG. 6, a perspective view of one neck clamping unit 110 of the at least two clamping units 110 is shown. Each neck clamping unit 110 includes an upper clamp portion 142 configured to connect to the touch panel 102, solenoid board 104, and/or the manifold unit 106. The upper clamp portion 142 includes a first upper clamp segment 142a and a second upper clamp segment 142b. Each first upper clamp segment 142a and each second upper clamp segment 142b is configured to engage the touch panel 102, solenoid board 104, and/or the manifold unit 106 via screws, welding, adhesives, and/or any other suitable fastening mechanism. The first upper clamp segment 142a of the upper clamp portion 142 connects with a lower clamp portion 144 via hinges 146, such that each upper clamp portion 142 is pivotable with respect to a corresponding lower clamp portion 144 about an axis of the hinge 146. In an exemplary embodiment, the upper clamp portion 142 comprises an extension arm 148 with a locking tab 150; and the lower clamp portion 144 comprises locking opening 152. In the exemplary embodiment, when the upper clamp portion 142 pivots towards the lower clamp portion 144, the locking tab 150 is configured to be inserted into the locking opening 152 to thereby prevent unintentional rotation of the upper and lower clamp portions 142, 144.

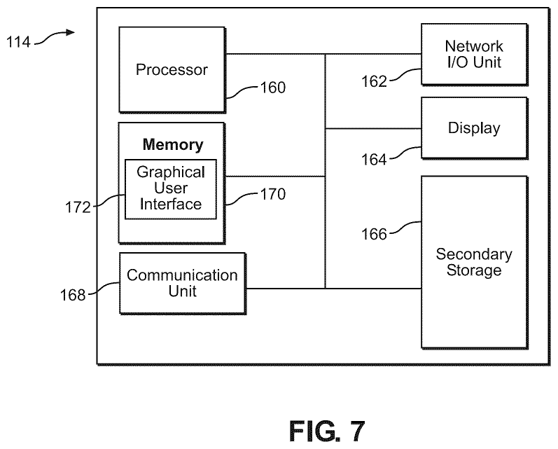

Referring now to FIG. 7, an exemplary embodiment of microcontroller 114 is shown. The microcontroller 114 includes a processor 160, a network I/O Unit 162, a display 164, a secondary storage unit 166, a communication unit 168, and a memory 170 running a graphical user interface (GUI) 172. In one embodiment, the processor 160 may be a central processing unit (CPU), an application specific integrated circuit (ASIC), a microprocessor, and/or any other suitable processing device. The memory 170 may include a hard disk, random access memory, cache, removable media drive, mass storage, or configuration suitable as storage for data, instructions, and information. In one embodiment, the memory 170 and processor 160 may be integrated. The memory 170 may use any type of volatile or non-volatile storage techniques and mediums. The network I/O unit 162 may be a network interface card, a plain old telephone service (POTS) interface card, an ASCII interface card, or any other suitable network interface device. Network I/O device 162 may include digital and analog control outputs for controlling external devices.

The microcontroller 114 may connect to a network including any private or public communication network known to one skilled in the art such as a Local Area Network (“LAN”), Wide Area Network (“WAN”), Peer-to-Peer Network, Cellular network or any suitable network, using standard communication protocols. The network may also be a Bluetooth point to point connection.

The microcontroller 114 may connect to an external device, such as a cellular phone or computer to allow for active interactions between the user 910 of the guitar 900 and the guitar playing system 100. In one embodiment, the microcontroller 114 may input string progressions from an external source and queue the string progressions to show the user 910 how to play music generated in a string progression. In another embodiment, the user 910 plays a string progression and the microcontroller 114 sends the string progression to the external device to store the string progression as a new song or portion of a song.

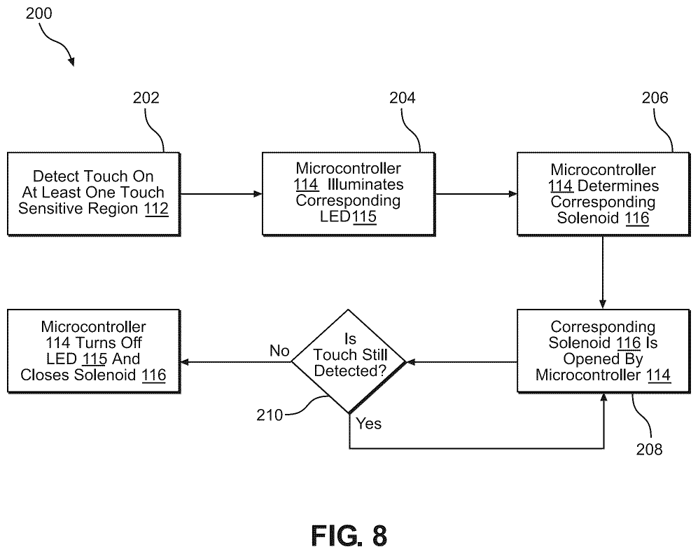

Referring now to FIG. 8, a schematic representation of a method 200 of operating the guitar playing system 100 is shown. In step 202, touch is detected on at least one touch sensitive region 112 of the plurality of touch sensitive regions 112. In step 204, the microcontroller 114 sends a signal to the at least one LED 115 at the corresponding touch sensitive region 112, when touch is detected, such that the at least one LED 115 illuminates. In step 206, the microcontroller 114 determines the solenoid 116 of the plurality of solenoids 116 associated with the touch sensitive region 112, when touch is detected. In step 208, the microcontroller 114 sends an actuation signal to the solenoid 116, corresponding to the touch sensitive region 112 where touch is detected, to open. The solenoid 116 opens to allow the air supply to pass therethrough, through the air hole 136, and through the air passage 134 to the corresponding piston 108. The air supply causes the piston 108 to actuate such that the piston shaft moves to the extended position with piston head 140 in contact with the guitar string. In step 210, the microcontroller 114 determines if touch is still detected at the touch sensitive region 112. If touch is no longer detected, the microcontroller 114 sends a signal to the at least one LED 115 to turn off and sends a signal to the solenoid 116 to close. When the solenoid 116 closes, the air supply no longer flows to the piston 108 and the piston shaft moves to the retracted position under influence of the piston spring.

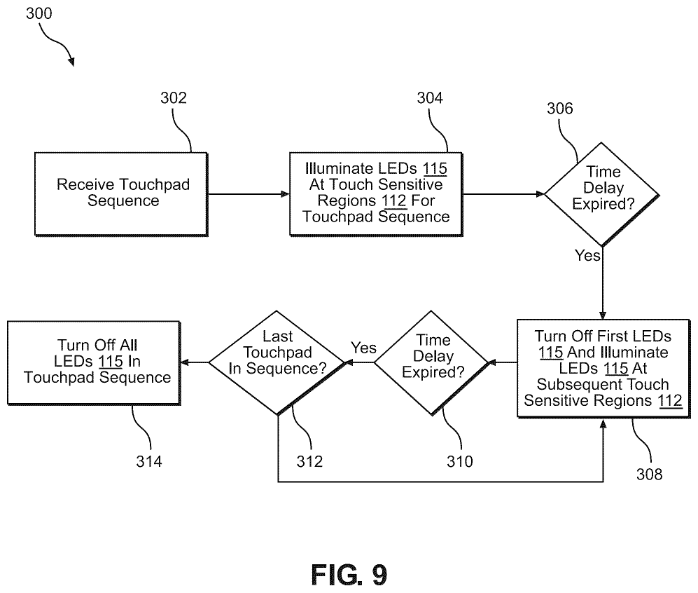

Referring now to FIG. 9, a schematic representation of a method 300 of operating the guitar playing system. In step 302, a touchpad sequence is received into the microcontroller 114. In an exemplary embodiment, the touchpad sequence is generated from a song that is uploaded into the microcontroller 114. The song may be represented by a series of chord progressions with associated timing of each chord included in the sequence. In step 304, the microcontroller 114 sends a command to the at least one LED 115 associated with each touch sensitive region 112 corresponding to a first fret of the touch pad sequence. The command illuminates the touch sensitive regions 112 on the fret to indicate where the user 910 should position their fingers to play the chord. In step 306, the microcontroller 114 waits for a predetermined time to expire. When the timer has expired, the microcontroller 114 turns off the at least one LED 115 at the first fret before illuminating the at least one LED 115 (step 308) associated with each touch sensitive region 112 corresponding to a subsequent fret. In step 310, the microcontroller 114 waits for a timer to expire. In step 312, after the timer has expired, the microcontroller 114 turns off the at least one LED 115 at the subsequent fret and determines if additional subsequent frets are included in the sequence. If additional subsequent frets are included in the sequence, the microcontroller 114 repeats steps 308-312. In step 314, if no additional subsequent frets are included in the sequence, the microcontroller 114 turns off all LEDs 115 of the at least one LED 115.

Those skilled in the art will recognize improvements and modifications to the preferred embodiments of the present disclosure. All such improvements and modifications are considered within the scope of the concepts disclosed herein and the claims that follow.

What is claimed is:

1. A guitar playing unit, comprising:
a touch panel comprising a plurality of touch sensitive regions electronically connected to a microcontroller;
a solenoid board supporting a plurality of solenoids, wherein each touch sensitive region of the plurality of touch sensitive regions is associated with and electronically connected to at least one solenoid of the plurality of solenoids, each solenoid being in fluid communication with an air source;
a manifold unit comprising a plurality of air holes, wherein each air hole of the plurality of air holes is in fluid communication with at least one solenoid of the plurality of solenoids;
a plurality of pistons in fluid communication with the plurality of air holes, wherein each piston of the plurality of pistons comprises a piston head configured to engage a string of a guitar at a fret location; and
a neck clamping unit configured to secure the guitar playing unit to a neck of the guitar.

2. The guitar playing unit of claim 1, wherein the microcontroller is configured to detect if a user has touched one or more of the plurality of touch sensitive regions.

3. The guitar playing unit of claim 2, wherein, when one touch sensitive region of the plurality of touch sensitive regions is touched, the microcontroller sends an actuation signal to the corresponding at least one solenoid to open.

4. The guitar playing unit of claim 3, wherein, when the at least one solenoid is open, air flows from the air supply to the corresponding piston of the plurality of pistons, thereby causing the piston to extend and contact the guitar string.

5. The guitar playing unit of claim 1, wherein the plurality of pistons comprises one or more piston sub-groups, each piston sub-group corresponding to a different fret location on the guitar.

6. The guitar playing unit of claim 1, wherein the manifold unit comprises an upper manifold plate, a manifold gasket, and a lower manifold plate.

7. The guitar playing unit of claim 6, wherein the upper manifold plate comprises a plurality of air passages in fluid communication with the plurality of air holes.

8. The guitar playing unit of claim 7, wherein:
each air passage of the plurality of air passages is located within a same plane,
each air hole of the plurality of air holes is substantially parallel, and
the plurality of air passages is substantially orthogonal to the plurality of air holes.

9. The guitar playing unit of claim 8, wherein a proximal end of each piston of the plurality of pistons is positioned adjacent one end of each air passage and in fluid communication therewith.

10. The guitar playing unit of claim 6, wherein the manifold gasket comprises a plurality of gasket piston openings and the lower manifold plate comprises a plurality of lower piston openings, each gasket piston opening aligned with and concentric with a corresponding one lower piston opening.

11. The guitar playing unit of claim 10, wherein each gasket piston opening and corresponding lower piston opening is configured to receive a piston body of a corresponding piston of the plurality of pistons.

12. The guitar playing unit of claim 1, wherein the neck clamping unit comprises an upper clamp portion pivotably connected to a lower clamp portion.

13. The guitar playing unit of claim 12, wherein the lower clamp portion is sized and shaped to receive at least a portion of the neck of the guitar.

14. The guitar playing unit of claim 12, wherein:
the upper clamp portion further comprises an extension arm with a locking tab,
the lower clamp portion further comprises a locking opening, and
when the upper clamp portion is pivoted towards the lower clamp portion, the locking tab is configured to be inserted into the locking opening.
